(19) United States
(12) Patent Application Publication
(10) Pub. No.: US 2008/0113268 A1
(43) Pub. Date: May 15, 2008

(54) Recombinant Hybrid Energy Storage Device

(76) Inventors: Edward R. Buiel, New Castle, PA (US); Victor Eshkenazi, Vaughan (CA); Leonid Rabinovich, Thornhill (CA); Wei Sun, New Castle, PA (US); Vladimir Vichnyakov, Newmarket (CA); Adam J. Swiecki, Milton (CA); Joseph E. Cole, New Castle, PA (US)

Correspondence Address: CAHN & SAMUELS LLP, 1100 17th STREET NW, SUITE 401, WASHINGTON, DC, 20036, US

(21) Appl. No.: 11/876,005

(22) Filed: Oct. 22, 2007

Related U.S. Application Data
(60) Provisional application No. 60/853,437, filed on Oct. 23, 2006.

(51) Int. Cl. H01M 10/20; H01M 4/68; H01M 2/16; H01M 4/56; H01M 4/58; H01M 4/62

(52) U.S. Cl. 429/228; 429/245; 429/247; 429/231.8; 429/217

(57) ABSTRACT

A hybrid energy storage device has at least one lead-based positive electrode and at least one carbon-based negative electrode, a separator between the electrodes, a casing which will contain the electrodes and separator, and an acid electrolyte. The separator is gas permeable, and is capable of absorbing and entraining acid electrolyte. The separator has a finite capacity for absorption of acid electrolyte, and the quantity of acid electrolyte which is present in the cell is less than the finite capacity of the separator. Upon assembly of the cell, the casing is sealed, and there is no liquid acid electrolyte within the assembled cell.

This application claims priority of U.S. Ser. No. 60/853,437 filed on Oct. 23, 2006, the entirety of which is incorporated by reference herein.

### FIELD OF INVENTION

The present invention relates to a hybrid energy storage device comprising at least one cell having at least one positive electrode, at least one negative electrode, a gas permeable separator, an acid electrolyte, and a casing. The amount of acid electrolyte placed in the at least one cell is less than the finite capacity for absorption of acid electrolyte by the gas permeable separator, at least one positive electrode, and at least one negative electrode.

### Background of the Invention

Hybrid energy storage devices, also known as asymmetric supercapacitors or hybrid battery/supercapacitors, combine battery electrodes and supercapacitor electrodes to produce devices having a unique set of characteristics including cycle life, power density, energy capacity, fast recharge capability, and a wide range of temperature operability. Hybrid lead-carbon energy storage devices employ lead-acid battery positive electrodes and supercapacitor negative electrodes. See, for example, U.S. Pat. Nos. 6,466,429; 6,628,504; 6,706,079; 7,006,346; and 7,110,242.

The conventional wisdom is that hybrid energy storage devices that are assembled and intended for commercial utilization require cells within the device to be flooded by an acid electrolyte.

When a hybrid lead-carbon-acid energy storage device is flooded with liquid acid electrolyte, the positive and negative electrode potentials may be unstable in conditions of deep discharge or overcharge in particular. Accordingly, there is a risk of corrosion, especially of the lead-based positive electrode. There may also be a risk of gas production during charge conditions. In particular, sufficient oxygen and hydrogen gas may be generated due to electrolysis of the water content of the liquid acid electrolyte that pressure within the casing causes the valve to open. If the valve opens, acid electrolyte usually spews out of the casing, the device becomes dry, and the electrodes are damaged. The device is usually taken out of operation and disposed of.

The inventors have proven that it is not necessary to flood the cell of a hybrid energy storage device, contrary to the conventional wisdom. To assure that the cell is not flooded, the quantity of liquid acid electrolyte which is placed in a cell is less than the finite capacity for absorption of the electrolyte by the gas permeable separator, at least one positive electrode, and at least one negative electrode.

### SUMMARY OF THE INVENTION

It is an object of the present invention to reduce the instability of electrodes of a hybrid energy storage device in conditions of deep discharge or overcharge.

It is another object of the present invention to reduce or eliminate oxygen and hydrogen gas generation due to electrolysis of the water content of a liquid acid electrolyte.

It is another object of the present invention to reduce or prevent corrosion of a lead-based positive electrode.

It is an advantage of the present invention that a thinner separator may be used than employed in conventional hybrid energy storage devices.

The above objects and advantages are satisfied by a hybrid energy storage device comprising at least one cell comprising at least one lead-based positive electrode, at least one carbon-based negative electrode, a separator between the electrodes, a casing which contains the electrodes, separator, and an acid electrolyte. The separator is gas permeable. The quantity of acid electrolyte in the at least one cell is less than a finite capacity for absorption of the acid electrolyte by the gas permeable separator, at least one positive electrode, and at least one negative electrode.

As used herein “substantially”, “generally”, “relatively”, “approximately”, and “about” are relative modifiers intended to indicate permissible variation from the characteristic so modified. It is not intended to be limited to the absolute value or characteristic which it modifies but rather approaching or approximating such a physical or functional characteristic.

References to “one embodiment”, “an embodiment”, or “in embodiments” mean that the feature being referred to is included in at least one embodiment of the invention. Moreover, separate references to “one embodiment”, “an embodiment”, or “in embodiments” do not necessarily refer to the same embodiment; however, neither are such embodiments mutually exclusive, unless so stated, and except as will be readily apparent to those skilled in the art. Thus, the invention can include any variety of combinations and/or integrations of the embodiments described herein.

In the following description, reference is made to the accompanying drawings, which are shown by way of illustration to specific embodiments in which the invention may be practiced. The following illustrated embodiments are described in sufficient detail to enable those skilled in the art to practice the invention. It is to be understood that other embodiments may be utilized and that structural changes based on presently known structural and/or functional equivalents may be made without departing from the scope of the invention.

### BRIEF DESCRIPTION OF THE DRAWINGS

FIG. 1 illustrates a cell of a hybrid energy storage device having a voltage potential between the positive electrode and negative electrode.

FIG. 2 illustrates an assembled cell of a hybrid energy storage device having a predetermined quantity of liquid acid electrolyte placed in the cell without flooding the cell.

FIG. 3 is a graph showing electrode potentials of the positive and negative electrodes of a cell during a constant current charging operation over time.

FIG. 4 illustrates a negative electrode of a hybrid energy storage device according to an embodiment of the present invention.

### DETAILED DESCRIPTION OF THE INVENTION

According to the present invention, a hybrid energy storage device comprises at least one cell having at least one lead-based positive electrode, at least one carbon-based negative electrode, a separator between the electrodes, an acid electrolyte, and a casing. The at least one cell contains substantially no free liquid acid electrolyte. Because the at least one cell is not completely flooded, there is no tendency for gaseous oxygen to bubble off from the at least one cell.

At least a portion of the acid electrolyte that is conventionally stored in a separator may be stored in the at least one negative electrode of the present invention. According to the present invention, the acid electrolyte is absorbed substantially by the separator and the at least one carbon-based negative electrode. As a result, the separator may be made thinner than those conventionally used. For example, the separator may have a thickness of about 0.5 mm, instead of about 2 mm for conventional devices.

The reduced thickness of the separator allows for greater gas passage between the electrodes, as the passage length between electrodes is decreased. As a result, any evolution of oxygen at the at least one positive electrode passes to the at least one negative electrode and recombines with hydrogen to form water with greater efficiency than a conventional hybrid energy device.

According to the present invention, more electrolyte may be added to the at least one cell than in conventional hybrid energy devices. The amount of acid electrolyte which is absorbed by and entrained in the gas permeable separator, the at least one positive electrode, and the at least one negative electrode is in the range of about 92% to about 98%, preferably about 95% to about 98%, of the finite capacity for absorption of the acid electrolyte by the cell. The amount of electrolyte absorbed in the separator and electrodes is measured by filling the at least one cell until pooling of the electrolyte is visible (mL of electrolyte filled). Alternatively, the at least one cell may be overfilled with electrolyte and the excess dumped (weight of the at least one cell before and after). Energy density of the hybrid energy device is also increased.

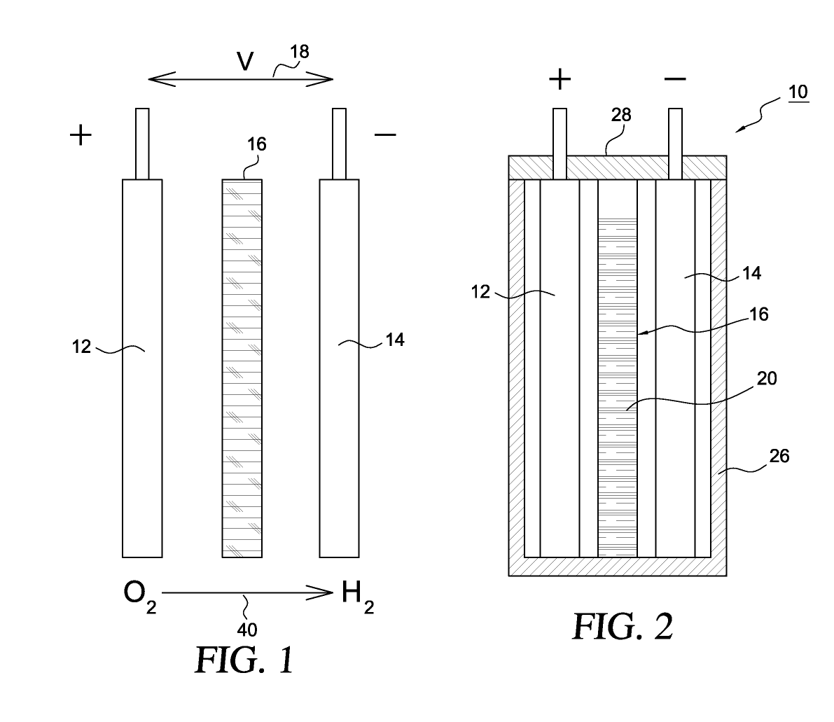

FIG. 1 illustrates a positive electrode 12 and a negative electrode 14 for a cell 10 having a separator 16 between them. A voltage differential V exists between the electrodes 12 and 14, as shown by arrow 18.

According to the prior art, oxygen evolution occurs at the surface of the positive electrode 12 during a charging cycle, gaseous oxygen migrates as bubbles through the gas permeable separator 16 to the surface of the negative electrode 14, where it is reduced electrochemically. At the same time, when charging is almost complete, gaseous hydrogen may be generated at the surface of the negative electrode 14.

The generation of oxygen gas and hydrogen gas are a result of electrolysis of the water content of the liquid acid electrolyte which is entrained within the structure of the gas permeable separator 16. Also, primarily it is the oxygen which migrates towards the negative electrode, with very little if any hydrogen migration towards the positive electrode. The oxygen migration shown by arrow 40 results in its depolarization to form water which will return to the liquid electrolyte entrained within the cell. This is in keeping with the following reaction:

O₂+4H⁺+4e⁻→2H₂O

FIG. 2 illustrates a cell 10 of a hybrid energy storage device according to the present invention.

According to the present invention, the positive electrode 12 is primarily lead-based. The lead-based positive electrode may comprise a lead current collector and an active material comprising lead dioxide in electrical contact with the lead current collector.

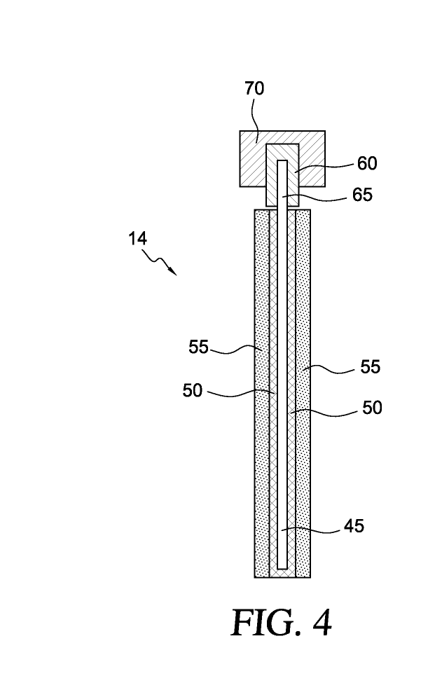

The negative electrode according to the present invention 14 is primarily carbon-based. As shown in FIG. 4, the carbon-based negative electrode 14 may comprise a current collector 45, a corrosion-resistant conductive coating 50, and an active material 55. The negative electrode may also have a lead lug 60 encapsulating a tab portion 65, and a cast-on strap 70. In certain embodiments, the tab portion may be the same material or a different material than the current collector.

The current collector of the negative electrode comprises a conductive material. For example, the current collector may comprise a metallic material such as beryllium, bronze, leaded commercial bronze, copper, copper alloy, silver, gold, titanium, aluminum, aluminum alloys, iron, steel, magnesium, stainless steel, nickel, mixtures thereof, or alloys thereof. Preferably, the current collector comprises copper or a copper alloy. The material of the current collector 20 may be made from a mesh material (e.g., copper mesh). The current collector may comprise any conductive material having a conductivity greater than about 1.0×10⁵ siemens/m. If the material exhibits anisotropic conduction, it should exhibit a conductivity greater than about 1.0×10⁵ siemens/m in any direction.

A corrosion-resistant conductive coating may be applied to the current collector. The corrosion-resistant conductive coating is chemically resistant and electrochemically stable in the in the presence of an electrolyte, for example, an acid electrolyte such as sulfuric acid or any other electrolyte containing sulfur. Thus, ionic flow to or from the current collector is precluded, while electronic conductivity is permitted.

The corrosion-resistant coating preferably comprises an impregnated graphite material. The graphite is impregnated with a substance to make the graphite sheet or foil acid-resistant. The substance may be a non-polymeric substance such as paraffin or furfural. Preferably, the graphite is impregnated with paraffin and rosin.

The active material of the negative electrode comprises activated carbon. Activated carbon refers to any predominantly carbon-based material that exhibits a surface area greater than about 100 m²/g, for example, about 100 m²/g to about 2500 m²/g , as measured using conventional single-point BET techniques (for example, using equipment by Micromeritics FlowSorb III 2305/2310). In certain embodiments, the active material may comprise activated carbon, lead, and conductive carbon. For example, the active material may comprise 5-95 wt. % activated carbon; 95-5 wt. % lead; and 5-20 wt. % conductive carbon.

The active material may be in the form of a sheet that is adhered to and in electrical contact with the corrosion-resistant conductive coating material. In order for the activated carbon to be adhered to and in electrical contact with the corrosion-resistant conductive coating, activated carbon particles may be mixed with a suitable binder substance such as PTFE or ultra high molecular weight polyethylene (e.g., having a molecular weight numbering in the millions, usually between about 2 and about 6 million). The binder material preferably does not exhibit thermoplastic properties or exhibits minimal thermoplastic properties.

The separator 16 is gas permeable. The separator 16 is capable of absorbing and entraining an acid electrolyte. The separator may comprise at least one of an absorbent glass mat material, a fused silica gel, or combinations thereof.

The cell also comprises a casing 26 which has a cover 28. The cover 28 seals the casing 26 after the cell has been assembled and placed therein. Thus, cell 10 is a closed system. Any gases which evolve within the cell are contained within the cell.

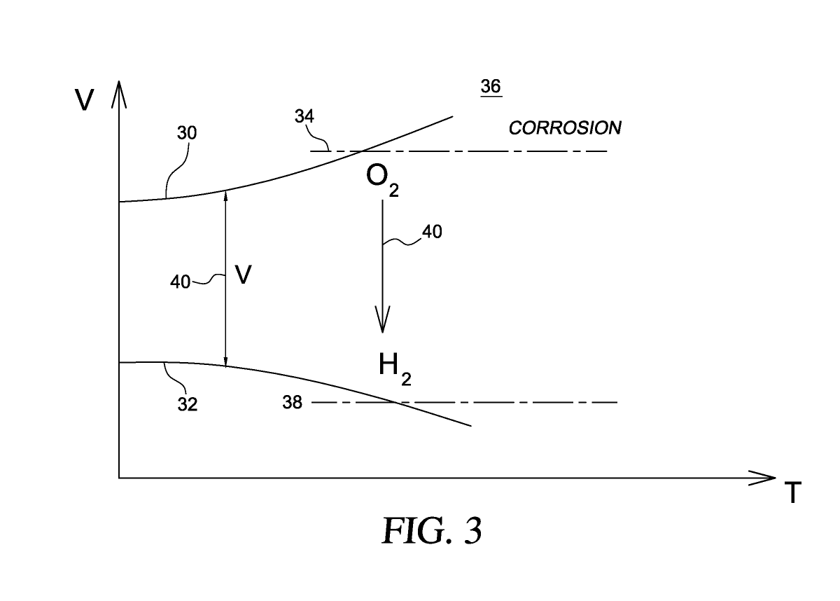

FIG. 3 is a graph showing electrode potential (V) versus time (T). An increasing potential differential 18 between the positive electrode potential shown by curve 30, and the potential of the negative electrode shown by curve 32, occurs over time during a constant current charging operation.

In a conventional flooded cell, if the potential of the positive electrode 12 is increased beyond a specific potential shown at 34, then oxygen evolution at the positive electrode will be so severe that a corrosion regime 36 for the positive electrode will be entered. It is also possible that a significant hydrogen evolution may occur at the negative electrode when the potential of that electrode reaches the specific potential shown at 38.

### EXAMPLE

A group 27 (BCI standard battery size) PbC hybrid energy device having five negative electrodes comprising 82 parts activated carbon, 10 parts carbon black, and 8 parts PTFE; six positive electrodes comprising lead, and 10 separators each having a thickness of 0.5 mm takes about 680 ml of sulphuric acid electrolyte. The amount of sulphuric acid electrolyte absorbed and entrained is 92.5% of the finite capacity for absorption of the sulphuric acid electrolyte due to the structure of the negative electrodes.

A conventional group 27 lead acid battery having eight negative electrodes comprising lead/lead sulphate active material; seven positive electrodes comprising lead dioxide, and 14 separators each having a thickness of 2 mm takes about 735 ml of sulphuric acid electrolyte. The amount of sulphuric acid electrolyte absorbed and entrained is 72% of the finite capacity for absorption of the sulphuric acid electrolyte. Conventional wisdom would suggest that using 10 pieces of 0.5 mm separator would only about one fourth the absorption capacity (about 18%).

Although specific embodiments of the invention have been described herein, it is understood by those skilled in the art that many other modifications and embodiments of the invention will come to mind to which the invention pertains, having benefit of the teaching presented in the foregoing description and associated drawings.

It is therefore understood that the invention is not limited to the specific embodiments disclosed herein, and that many modifications and other embodiments of the invention are intended to be included within the scope of the invention. Moreover, although specific terms are employed herein, they are used only in generic and descriptive sense, and not for the purposes of limiting the description invention.

What is claimed is:

1. A hybrid energy storage device, comprising:
at least one cell comprising at least one positive electrode, at least one negative electrode, a separator therebetween, an acid electrolyte, and a casing;
wherein the amount of acid electrolyte which is absorbed by and entrained in the separator, at least one positive electrode, and at least one negative electrode is in the range of about 95% to about 98% of the finite capacity for absorption of the acid electrolyte by the cell,
wherein said at least one cell contains substantially no free liquid acid electrolyte within the casing for said at least one cell.

2. A hybrid energy storage device according to claim 1, wherein the separator has a thickness of about 0.5 mm.

3. A hybrid energy storage device according to claim 1, wherein the at least one positive electrode comprises a current collector comprising lead or lead alloy.

4. A hybrid energy storage device according to claim 3, wherein the at least one positive electrode further comprises an active material comprising lead dioxide in electrical contact with the current collector.

5. A hybrid energy storage device according to claim 1, wherein the at least one negative electrode comprises a current collector, a corrosion-resistant conductive coating, and an active material.

6. A hybrid energy storage device according to claim 1, wherein the current collector comprises copper or copper alloy.

7. A hybrid energy storage device according to claim 1, wherein the corrosion-resistant coating comprises graphite impregnated paraffin or furfural.

8. A hybrid energy storage device according to claim 5, wherein the active material comprises activated carbon mixed with PTFE or ultra high molecular weight polyethylene.

9. The hybrid energy storage device of claim 1, wherein the separator is selected from the group consisting of absorbent glass mat separator material, fused silica gel, and combinations thereof.
